(19) United States
(12) Patent Application Publication
(10) Pub. No.: US 2017/0161754 A1
(43) Pub. Date: Jun. 8, 2017

(54) COUNTER FRAUD SYSTEMS

(71) Applicant: Hattar Tanin LLC, Novato, CA (US)

(72) Inventors: Saadeh Hattar, Novato, CA (US); Volodymyr Tanin, Kiev (UA)

(21) Appl. No.: 15/372,274

(22) Filed: Dec. 7, 2016

Related U.S. Application Data
(60) Provisional application No. 62/263,846, filed on Dec. 7, 2015.

(51) Int. Cl. G06Q 30/00; G06F 19/00

(52) U.S. Cl. CPC G06Q 30/0185; G06F 19/322

(57) ABSTRACT

The disclosure provides solutions to these and other problems by providing methods, systems, and software for consumer protection, document verification, and medical auditing.

### CROSS REFERENCE TO RELATED APPLICATIONS

This application claims priority to U.S. Provisional Patent Application No. 62/263,846, entitled “Innovative Counter-Fraud/Scam and Counter-Fake Systems,” filed Dec. 7, 2015, which is hereby incorporated by reference.

### TECHNICAL FIELD

This specification describes technologies relating to methods, systems, and software for countering fraud.

### BACKGROUND

Fraudulent activities of commercial, professional, and personal nature are costly and increasingly problematic in the electronic era. For example, counterfeiting of commercial brands and marketing of false goods harms the manufacturer, the retailer, and the consumer. Forgery and/or modification of original documents likewise harm governments, companies, and individuals. As does fraudulent medical billing and treatment which can result in bodily harm or even death. Current systems for detecting and/or avoiding fraud need improvement.

### SUMMARY

The disclosure provides solutions to these and other problems by providing methods, systems, and software for consumer protection, document verification, and medical auditing.

The following presents a summary of the present disclosure in order to provide a basic understanding of some of the aspects of the present disclosure. This summary is not an extensive overview of the present disclosure. It is not intended to identify key/critical elements of the invention or to delineate the scope of the invention. Its sole purpose is to present some of the concepts of the present disclosure in a simplified form as a prelude to the more detailed description that is presented later.

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used.

Three counter fraud systems are disclosed herein.

The first system is a counter-fraud system for consumer goods, which keeps a product's history within the system in a special database that allows anybody, from state agencies to any local customer, to check the product origin, whole path and current location and/or ownership. For example, a customer can check whether the product should (may) be in particular shop.

The second system is a counter-fraud system for document verification that allows anybody to check any document registered in the system. Any documents produced by any individual or organization may be registered in the system. In some embodiments, the database only stores characterizations of the documents, rather than the original documents themselves.

Any documents produced by any individual and/or organization may be registered in the system preventing forgery. The documents may not be stored in the central database, may be stored only different their features/descriptors which may include, but are not limited to: a) creator's name, purpose of creation, to whom document was created, for what purposes it can be used; b) checksum(s) for the whole document, for each page and optionally for each line and/or unit of text; c) different features like the number of characters, words, number symbols, other symbols and blanks on each page, in each line are stored in the system. The system allows anybody (who has permission and/or needs) to verify the authenticity of the presented document. The documents, which exist only as hard copies may be processed by OCR and/or in any other way before registering and during verification.

The third system is a counter-fraud system for the identification of fraudulent medical professionals. Statistics on each medical professional are stored in a database and compared with statistics from other medical professionals practicing in the same field of specialization and/or region.

Information from all and/or specified insurance companies, and/or from all other possible sources, is collected on what medical services are provided by the exact medical specialist, their quantity, price, specifics. There is no need to identify the patient, which remains anonymous.

Getting all the information concerning quantity, specifics, types of provided services, a unique ID is created for every medical specialist which is compared with IDs (e.g., the data associated with each ID) of the same sphere and specialization medical specialists. IDs of abovementioned specialists can be compared in frames of specified territories and/or all over the country. IDs of abovementioned specialist can be compared using any necessary criteria and statistic/mathematical instruments. Any deviation, assumed significant, provides purpose to carry out check from the side of governmental authorities, insurance companies, and/or from the side of anybody else.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating possible chain of custody for a consumer good and a method/system for tracking and verifying the source of the good, in accordance with some implementations.

FIG. 2 is a block diagram illustrating method/system for verifying the authenticity of a document, in accordance with some implementations.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

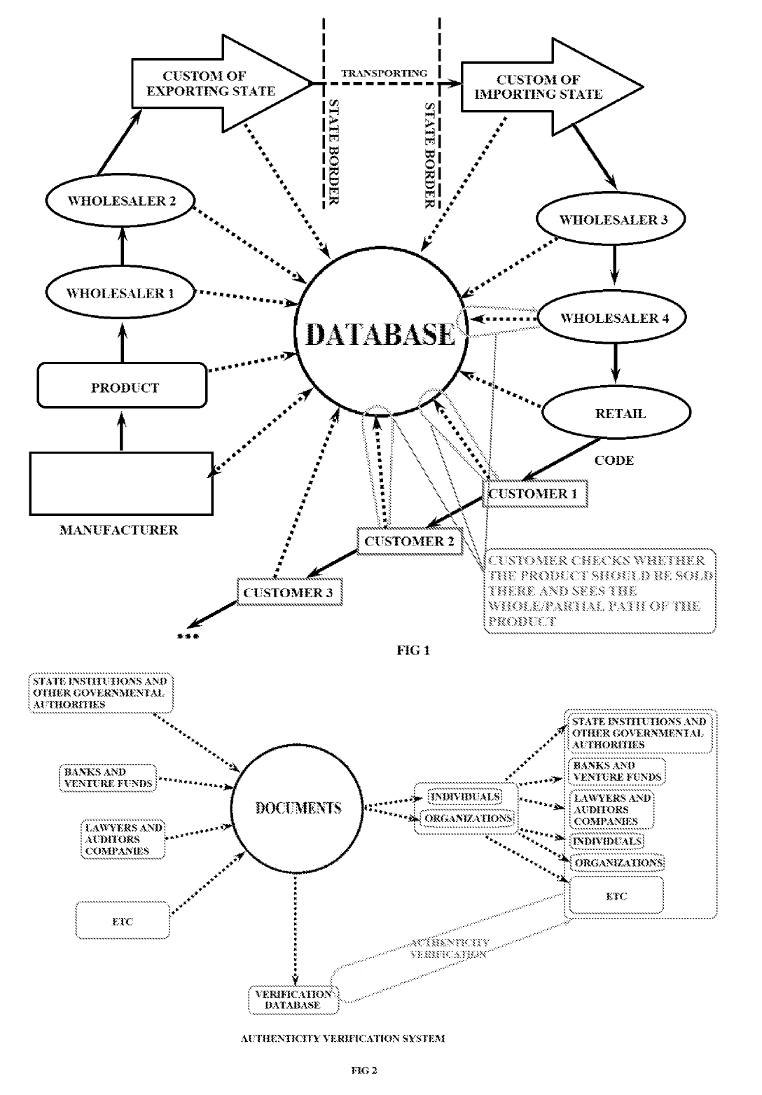

Referring to FIG. 1, a first system is provided for authenticating the source of consumer goods. In some embodiments, as illustrated in FIG. 1, the service is an online service. The main idea of this counter-fake system (hereinafter system) is that every producer, who is engaged in this system and uses it, marks/labels every separate and/or specified, and/or sellable goods unit (unit, which can be marked with code) with special unique code (which can be represented by letters, numbers, exact time and/or in any other way(s)), codes can be also accompanied by any necessary figures/figure codes (like barcode, QR-code . . . ) (hereinafter named as code(s)). These codes can be generated in any way(s), but we consider that the best mode, when such codes are generated by the proposed system and provided to the exact producer.

Using generated codes, producer marks every unit of goods with unique code, and he can also add unique-code-supporting information (hereinafter supporting information), like photo of the marked goods unit, form, formula, dosage, weight, color and any other possible characteristic(s) and/or property(ies) of the marked unit. For example, in case of medication it is possible to provide information concerning dosage, formula name, brand name, medical form, packing, number of tablets, if it is tablets, in package and/or in blister package, image of goods unit . . . and so on. Code together with this abovementioned supporting information, being attached to the code (with which unit of goods is marked/labeled), is returned back to the system (e.g., the database in FIG. 1).

When selling batch/lot of goods to the exact buyer (buyer can and/or must be also registered in the system), the producer informs the system, about codes of all goods units, which are in the sold batch/lot, what is the country of destination, who is the buyer, and any other necessary information. When goods are arriving to the destination country, the current goods owner must notify the system that goods are in the country. In case of reselling of goods to the second-step buyer (second-step buyer must and/or can be also register in the system), the current goods owner (first-step buyer in this case) can and/or must inform the system concerning goods units (codes of goods units), which he is selling to the second-step buyer. And so on. Current owner can and/or must also mark state, region, county, district . . . where sold goods units will be provided to the market for selling. Such tracking of goods can be carried out up to the exact shop with physical address, where exact goods unit will be purchased by the exact final buyer/final consumer (in case of necessity, for special cases and/or by the wish of final buyer, he can be also registered in the system as the buyer of the exact/specified goods unit with corresponding code). When selling to the final consumer/final buyer exact goods unit(s), the seller can and/or must inform system that his exact goods unit(s) is/are sold. Every time when goods unit is sold by the current seller to the current buyer, the system can be and/or must be informed.

Such system provides possibility to any person(s) (and/or to specified person(s)) to define whether these goods are really produced by the pointed producer, are these goods imported to the country in the legal way, does this exact seller has right to sell this exact goods unit. Using such system there is no possibility for non-honest businessman to make legal purchase of, for example, 10 goods units and illegal purchase of 100 goods units, but selling all 110 goods units, as legal ones.

This system provides every person and every buyer with instrument to control the seller and to control what exactly he is buying. Unfortunately, Government can't provide police officer to each seller, but using such system government can provide people with instrument of permanent control. Likewise, this system also provides companies with the ability to protect their brand name and their customers, by providing all controllers and all buyers with powerful instrument of control. Nearly everybody (with access to the internet in hand) can carry out control.

This system also enables the identification of parties who are responsible for the fraud, by tracking the complete chain of custody for a product. This increases enforcement for fraud-related crimes.

The general scheme is illustrated in FIG. 1. The entire history of a product is stored within the database and may be checked by any government agency, retailer, or consumer. In some embodiments, the consumer may or is required to register within the system. In other embodiments, the consumer can check the chain of custody and/or the source of the good without registering.

Referring to FIG. 2, the second system described herein is a counter-fraud system for the quick identification of fake/falsified documents. In some embodiments, the system is an online system, where documents or any other form of file (e.g., digital files including photos) are registered and receive a unique identification (e.g., a code, number, barcode, QR-code, registration time, creation time and/or any other information). An entry for the document is created containing the ID, and any other biographical data for the document, e.g., the creator's name, purpose of creation, to whom document was created, for what purposes it can be used, etc.

If a document exists in digital form, one or more checksum(s) may be calculated and stored, associated with the unique identification, at the server. Several/necessary/specified checksums may be calculated as well as the same type of checksum may be used several times to calculate the checksums of the document with different salts added.

In some embodiments, one or more salt is associated with the document and/or calculated checksums. In cryptography, a salt is random data that is used as an additional input to a one-way function that hashes a password or passphrase. In some embodiments, the salt is concatenated to a particular checksum and a one-way function (e.g., a one-way hash function) is used to create a hashed-checksum, to improve security. In some embodiments, the checksums corresponding to the number of lines on a page or document, the number of words on a page or document, the number of pages, etc., is used to calculate a checksum.

In some embodiments, if the document is a text document, the text may be extracted from it and checksum(s) may be separately calculated for the text. The checksums may be also calculated for the whole text, for the text on each page and for each line of text. The checksum(s) may be separately calculated for the main text without headers and/or footers. In some embodiments, calculation of the checksums is done on local computer of the user. Besides the checksums some additional information like number of words, characters, number symbols, other symbols and blanks in each line and/or on each page/and/or in each cell may be calculated and stored in the system. Only the checksums and other additional information described above will be stored on the server and used to verify the documents. The document itself may never be sent to the server.

In some embodiments, the system is used to verify hard copies of a document. In some embodiments, text is extracted (e.g., from OCR) allowing for the calculation of one or more checksum for the document. In some embodiments, a hard copy of the document may be scanned or photographed, converted to the text format using OCR (optical character recognition) and/or anything else (including like being retyped) and verified by a special computer software able to calculate the necessary checksums and/or other parameters (for the whole document and/or for each page, and/or for each line, and/or for any other certain part of the document).

The document may not exist in digital form. In this case it should be scanned or photographed. After being subjected to OCR procedure (and/or any other procedure to make electronic version) the document can be entered into the system with all checksums and other supporting information.

For example, auditors may register their reports in this fashion, such that if the documents are later modified, for example by modifying information, the system will detect changes in the checksums of the document.

In some embodiments, access to the system can be provided to anyone. In other embodiments, access to the database is restricted to specified (e.g., registered) users. In other embodiments, different users are assigned different levels of access and/or access to specific document groups. The general scheme for this document authenticity verification system is illustrated in FIG. 2.

The third counter-scam system described herein is developed to identify fraudulent medical workers, such as surgeons who bill patients and/or insurers for procedures that were not performed.

In some embodiments, information from insurance companies and/or other medical sources (e.g., hospitals, trauma centers, etc.) on what medical services are collected for medical workers, e.g., the quantity, price, specifics and/or any other information on services rendered or billed. There is no need to identify the personality of patient, who remains anonymous.

A unique identity (ID) is associated with each medical professional, and is associated with the collected information on that medical professional (e.g., information concerning quantity, specifics, types of provided services and/or any other information) and stored in a database. Data assembled for each medical professional is then compared to data collected for other medical professionals. In some embodiments, the comparison is done between medical professionals with similar profiles (e.g., same specialization, area or practice, regional location, etc.). Any known statistical method or criteria can be used to make the comparison. The system then identifies medical professionals with statistical profiles that are significantly different from their peers.

For example, where one specialist and/or specialists within a certain area are only performing one type of operation, or performing a higher number of procedures, or assigning a particular therapy with a significantly higher frequency than their peers, the system will identify them. This provides a rational for further investigating the identified medical professional (e.g., by an insurance company, government agency, etc.).

In some embodiments, this system is applied to one or more of doctors, surgeons, nurses, pharmacists, psychiatrists, etc.

### Exemplary Embodiments.

In one aspect, the disclosure provides consumer protection methods, systems, and software. In some embodiments, the system includes a first electronic device associated with a verification server, the first electronic device having one or more processors and a memory, the memory storing non-transitory instructions which, when executed by the one or more processors, cause the electronic device to: responsive to receiving, from a second electronic device associated with a manufacturer (e.g., the actual manufacturer or an entity who contracted the actual manufacturer to make the product (e.g., an organization that owns the brand of the product)) located in a first jurisdiction (e.g., a state or country), a first plurality of product identifications, each product identification in the first plurality of product identifications corresponding to a unit of a first manufactured product in a plurality of units (e.g., a lot) of the first manufactured product: assign a plurality of product verification entries, each product verification entry in the plurality of product verification entries associated with (e.g., including) a respective product identification in the plurality of product identifications and an identity of the manufacture (e.g., a name, location, and/or government business license number).

The instructions further cause the electronic device to, responsive to receiving, from a third electronic device associated with a first merchant (e.g., a wholesaler or retailer), a first sub-plurality of product identifications in the first plurality of product identifications corresponding to a first sub-plurality of units in the first plurality of units of the first manufactured product received by the first merchant, update product verification entries in the plurality of product verification entries corresponding to each of the first sub-plurality of product identifications in the first plurality of product identifications to include an identity of the first merchant, and optionally, transmit, to the third electronic device associated with the first merchant, a chain of custody including at least confirmation that the first sub-plurality of units in the plurality of units of the first manufactured product received by the first merchant were manufactured by the first manufacturer (e.g., the first manufacturer actually manufactured or contracted-out the manufacture of the units).

Responsive to receiving, from a fourth electronic device associated with a first customs agency of the first jurisdiction, a second sub-plurality of product identifications in the first plurality of product identifications corresponding to a second sub-plurality of units in the first plurality of units of the first manufactured product to be exported from the first jurisdiction, wherein the second sub-plurality of units is also a sub-plurality of the first sub-plurality of units:

The instructions further cause the electronic device to, update product verification entries in the plurality of product verification entries corresponding to each of the second sub-plurality of product identities in the first plurality of product identifications to include an identity of the first customs agency of the first jurisdiction, and optionally, transmit, to the fourth electronic device associated with the first customs agency of the first jurisdiction, a chain of custody including at least confirmation that the second sub-plurality of units in the plurality of units of the first manufactured product to be exported from the first jurisdiction were manufactured by the first manufacturer.

The instructions further cause the electronic device to, responsive to receiving, from a fifth electronic device associated with a second customs agency of a second jurisdiction that is different from the first jurisdiction, the second sub-plurality of product identifications in the first plurality of product identifications corresponding to the second sub-plurality of units in the first plurality of units of the first manufactured product to be exported into the second jurisdiction, update product verification entries in the plurality of product verification entries corresponding to each of the second sub-plurality of product identifications in the first plurality of product identifications to include an identity of the second customs agency of the second jurisdiction, and optionally, transmit, to the fifth electronic device associated with the second customs agency of the second jurisdiction, a chain of custody including at least confirmation that the second sub-plurality of units in the plurality of units of the first manufactured product to be exported into the second jurisdiction were manufactured by the first manufacturer.

The instructions further cause the electronic device to, responsive to receiving, from a sixth electronic device associated with a second merchant (e.g., a retail distributor in the second jurisdiction or a final retailer), a third sub-plurality of product identifications in the first plurality of product identifications corresponding to a third sub-plurality of units in the first plurality of units of the first manufactured product to be sold direct to consumers (e.g., by the second merchant), wherein the third sub-plurality of units is also a sub-plurality of the second sub-plurality of units, update product verification entries in the plurality of product verification entries corresponding to each of the third sub-plurality of product identifications in the first plurality of product identifications to include an identity of the second merchant, and optionally, transmit, to the sixth electronic device associated with the second merchant, a chain of custody including at least confirmation that the third sub-plurality of units in the first plurality of units of the first manufactured product to be sold direct to consumers were manufactured by the first manufacturer;

The instructions further cause the electronic device to, responsive to receiving, from a seventh electronic device associated with a consumer, a respective product identification in the third sub-plurality of product identifications corresponding to a respective unit in third sub-plurality of units in the first plurality of units of the first manufactured product (e.g., prior to, while, or after purchasing the product), transmit, to the seventh electronic device associated with the consumer, a chain of custody including at least confirmation that the respective unit in the third sub-plurality of units in the first plurality of units of the first manufactured product was manufactured by the first manufacture.

The instructions further cause the electronic device to, responsive to receiving, from an eighth electronic device associated with a final merchant (e.g., the final retailer, which may be the same of different from the second merchant), the respective product identification in the third sub-plurality of product identifications in the first plurality of product identifications corresponding to the respective unit in the third sub-plurality of units in the first plurality of units of the first manufactured product sold to a consumer by the final merchant: update the product verification entry in the plurality of product verification entries corresponding to the respective unit in the third sub-plurality of units in the first plurality of units of the first manufactured product sold to the consumer to indicate that the unit was sold to a consumer.

In some embodiments, the non-transitory instructions, when executed by the one or more processors, further cause the electronic device to, responsive to receiving, from one of the manufacture, the first merchant, or the second merchant, an identity of a final merchant authorized to sell the third sub-plurality of units in the first plurality of units of the first manufactured product, update product verification entries in the plurality of product verification entries corresponding to each of the third sub-plurality of product identifications in the first plurality of product identifications to include an identity of the authorized final merchant. And, responsive to receiving, from the seventh electronic device associated with the consumer the respective product identification in the third sub-plurality of product identifications corresponding to the respective unit in third sub-plurality of units of the first manufactured product, and an identity of a final merchant: determine whether the identity of the final merchant received from the seventh electronic device associated with the consumer matches the identity of the authorized final merchant stored in the product verification entry corresponding to the respective product identification in the sub-plurality of product identifications received from the seventh electronic device associated with the consumer. And, transmit, to the seventh electronic device associated with the consumer, an indication whether the final merchant identified by the consumer is authorized to sell the respective unit in the third sub-plurality of units of the first manufactured product.

In some embodiments, the anti-consumer fraud systems described herein relate to monitoring goods that travel though a more direct route to the consumer (e.g., do not include one or more wholesalers, customs agencies, etc. Accordingly, in some embodiments, the methods, systems, and software provided herein contain only a subset of the instructions described above. E.g., one or more merchants/wholesalers/intermediates and that is why certain record points/participants in marketing-chain-tracking may be substituted, added or skipped.

Taking into account that certain goods unit(s) may be marketed in the way, where in marketing chain between manufacturer and final consumer there can be no, one or more merchants/wholesalers/intermediates and that is why certain record points/participants in marketing-chain-tracking may be substituted, added or skipped, where goods units may not cross the border (no customs' recordings) or may pass one or more borders and that is why certain record points/participants in marketing-chain-tracking may be substituted, added or skipped, —stages of goods unit(s) tracking may be different, but system will keep functioning conforming to the (1) principle, where tracking of goods unit(s) identifier(s) may be carried out by recording the owners of certain goods units in marketing chain from manufacturer to the final consumer (i.e. tracking of goods unit(s) by owners) or conforming to the (2) principle, where tracking of goods unit(s) identifier(s) may be carried out by recording the owners of certain goods units in marketing chain from manufacturer to the final consumer taking into account the time/period of ownerships and/or goods unit(s) location (i.e. tracking of goods unit(s) by owners in time and/or by location).

In one aspect, the disclosure provides document verification methods, systems, and software. In one embodiment, the method includes a computer-implemented method for confirming authenticity of a first document, performed on a server having at least one processor and memory storing at least one program for execution by the at least one processor to perform the method. Responsive to receiving from a first remote source first biographical data on the first document and a first checksum calculated according to a first checksum algorithm using a first sub-set of data from the document, performing an onboarding procedure that includes assigning a first document validation identity to the first document, optionally, concatenating a first salt to the first checksum, applying a first cryptographic one-way function (e.g., a cryptographic has function) to the first checksum and, optionally, concatenated first salt to generate a first hashed checksum, generating a first document validation entry for the first document, the first document validation entry including the first validation identity, the first biographical data, the first hashed checksum, and, optionally, the first salt (e.g., and, optionally, an identity of the first cryptographic hash function (e.g., wherein the first checksum is not stored in non-transitory computer readable memory by the first electronic device)), and transmitting the first document validation identity back to the first remote source.

The method also includes, conditionally confirming authenticity of the first document responsive to receiving, from a second remote source a request that includes the first document validation identity and a second checksum by a verification procedure that includes identifying the first document validation entry based on the first document validation identity received from the second remote source, optionally, retrieving the first salt from the identified first document validation entry, optionally, concatenating the first salt to the second checksum, applying the first cryptographic one-way function to the concatenated second checksum and first salt to generate a second hashed checksum, and transmitting, to the second remote source: in accordance with a determination that the second hashed checksum is identical to the first hashed checksum, an indication that the first document is authentic, and in accordance with a determination that the second hashed checksum is not identical to the first hashed checksum, an indication that the authenticity of the first document cannot be confirmed.

In some embodiments, each document/file, registered in Document Verification System is provided with identification number/identifier, which identifies the original checksum of the document, stored in the system, and which must be pointed together with generated checksum, which must be compared with checksum of original document.

In some embodiments, it is possible to identify in which part(s) of document (like line, text block, paragraph, page, cell of the table) modification took place, if it was, and/or whether it is the same document absolutely different (for example, by amount of pages in original and compared document), because checksum (and/or other document parameters) may be calculated either for the whole document and/or for the certain part of the document (like line, text block, paragraph, page, cell of the table).

In some embodiments, the document identifier enables identification of the author(s) of the document and/or signer(s) of the document (when signer(s) register form his(their) account(s) checksum and optionally other parameters of the document, which was signed by him/them).

In some embodiments, the verification/principle of verification includes generating a first mask of the document/file in the form of checksum+ other parameters, like amount of words, letters/symbols, digits in the line(s), paragraph(s), on the page(s) [in certain document unit] and/or their spatial location (hereinafter named as mask). The mask is registered in the verification system, and is assigned to an identifier (certain registration number) for the document/file, and records identifier to the document/file. Anybody, who gets the document, generates the second “mask” of the document and sends generated second “mask” of the document to the system together with identifier to compare generated second “mask” with original first mask of the document/file, which is stored in the system and conforms to the given identifier. System will be able to answer whether received document is original or modified.

In one aspect, the disclosure provides medical auditing methods, systems, and software. In one embodiment, the system includes an electronic device associated with an auditing server, the first electronic device having one or more processors and a memory, wherein the memory stores a medical auditing database. The database includes a plurality of medical professional records, each medical professional record in the plurality of medical professional records corresponding to a respective medical professional in a plurality medical professionals and including: an identity of the corresponding medical professional, a medical service classification of the corresponding medical professional (e.g., a type of medicine practiced by, or job classification of (e.g., doctors, surgeons, psychiatrists, nurses, pharmacists, etc.), the corresponding medical professional), and a plurality of medical services records, each medical service record in the plurality of medical services records corresponding to a service event (e.g., patient consultation, surgery, prescription, etc.) rendered by the corresponding medical professional and including a description of all medical charges arising out of (e.g., incurred during, and/or arising out of medical tests or surgical procedures ordered by the corresponding medical professional as a result of the service event), the service event (e.g., a list of billing codes, billed costs, or both arising from the service event).

The device also includes non-transitory instructions which, when executed by the one or more processors, cause the electronic device to generate a plurality of statistics for a first medical service classification, each statistic in the plurality of statistics for the first medical service corresponding to a measure of all medical charges associated with a first sub-plurality of medical services records corresponding to a medical professional associated with the first medical service classification (e.g., all charges incurred by oncologists over a given period of time).

The instructions also cause the device to rank each statistic in the plurality of statistics for the first medical service classification relative to each other statistic in the plurality of statistics for the first medical service, and display the identity of any medical professionals associated with a respective statistic in the plurality of statistics that is an outlier from the majority of other statistics (e.g., according to a statistical deviation or percentile rank), e.g., that deviates more than one standard deviation from a measure of central tendency, that deviates more than two standard deviation from a measure of central tendency, that deviates more than three standard deviation from a measure of central tendency, where the measure of central tendency is an arithmetic mean, weighted mean, midrange, midhinge, trimean, Winsorized mean, median, or mode of the statistic.

For example, a medical professional is identified when, for example, a particular surgery is necessary for 2-6% of a particular patient population, but is performed on more than ⅔ of this patient population. The medical professional may be doing this, for example, because the procedure nets a large profit after reimbursement from an insurance carrier.

In some embodiments, statistics used to identify outliers include, but are not limited to, the amount, type and frequency of certain operations/services per patient [Certain medical specialist can service, for example, 300 patients and other one—150, but when these both and other medical specialists in the same sphere are working in the same ecological and climate conditions, especially in the same city—average amount, type and frequency/percentage of certain from all provided services must be similar, when calculating per patient. If such parameters significantly deviate from average—it is purpose for the system to raise “red flag”];

In some embodiments, the statistics include a profit (e.g., per patient or per procedure), because some medical specialist can be more popular, someone less, but servicing significant amount of patients and having same tariffing per service from insurance companies, average earning per patient must be similar to the average earning per patient, gained by the other same-sphere specialists. If such parameter significantly deviates from average—it is purpose for the system to raise a red flag.

Earning per specialist may vary significantly, but when, thanks to provision of services for patients himself, certain medical specialist earns in times/in multiple times more, comparing with other same-sphere medical specialists—it is purpose for the system to raise a red flag.

In some embodiments, the metric is timing per specialist, which may indicate fraud where each service and especially complicated operation, if it is made in accordance with adopted protocol, has its specific minimal time-frames [it is impossible to make operation, which demands hour in average during 10 minutes], it is possible to summarize all average timings for provided services and, for sure, the amount of working hours must be in reasonable frames [it must not be, for example, 16 hours+ per day]. If such parameter significantly deviate from average/reasonable—it is purpose for the system to raise a red flag.

Certain services and operations cannot be carried out without qualified assistants, that is why such assistants first-must be present in medical office, second-they must have proper qualification, third-these assistants must be busy(i.e. paid for) with such assistant-demanding services and operations during averagely-necessary time for them. If such parameter significantly deviates from average/reasonable—it is purpose for the system to raise a red flag.

In some embodiments, drugs, devices and other expendable units/materials must be purchased by medical office in amounts, which conform to the quantity, which averagely must be spent during provided service/operations. If such parameters significantly deviate from average—it is purpose for the system to raise a red flag.

Above parameters can be used all together or selectively, or other specific statistical parameters can also added, but above listed parameters are key and main to identify possible crime.

### Cooncluding Remarks

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

Memory optionally includes high-speed random access memory and optionally also includes non-volatile memory, such as one or more magnetic disk storage devices, flash memory devices, or other non-volatile solid-state memory devices. Access to memory by other components of device, such as one or more processors and a peripherals interface, is, optionally, controlled by a memory controller.

A peripherals interface can be used to couple input and output peripherals of the device to one or more processors and memory. The one or more processors run or execute various software programs and/or sets of instructions stored in memory to perform various functions for device and to process data.

Each of the above identified modules and applications correspond to a set of executable instructions for performing one or more functions described above and the methods described in this application (e.g., computer-implemented methods). These modules (i.e., sets of instructions) need not be implemented as separate software programs, procedures or modules, and thus various subsets of these modules are, optionally, combined or otherwise re-arranged in various embodiments. In some embodiments, memory optionally stores a subset of the modules and data structures identified above. Furthermore, memory optionally stores additional modules and data structures not described above.

Accordingly, in other embodiments, the present disclosure provides electronic devices including one or more processors, memory, and optionally a display, where the memory includes instructions for performing all or a portion of one or more methods described herein. For example, electronic devices with instructions for performing only the portions of the disclosed methods associated with a first, second, third, etc., device are contemplated. E.g., in some embodiments, the electronic device includes instructions for performing steps associated with one or more of a consumer, merchant, customs agency, remote validation database, etc., as referred to in the methods disclosed herein.

In other embodiments, the present disclosure provides computer readable storage medium (e.g., non-transitory medium) storing one or more programs, the one or more programs including instructions, which when executed by an electronic device with one or more processors and optionally a display, cause the device to perform all or a portion of one or more methods described herein. For example, computer readable storage medium with instructions for performing only the portions of the disclosed methods associated with a first, second, third device, etc., device are contemplated. E.g., in some embodiments, the computer readable storage medium includes instructions for performing steps associated with one or more of a consumer, merchant, customs agency, remote validation database, etc., as referred to in the methods disclosed herein.

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A first electronic device associated with a verification server, the first electronic device having one or more processors and a memory, the memory storing non-transitory instructions which, when executed by the one or more processors, cause the electronic device to:
responsive to receiving, from a second electronic device associated with a manufacturer located in a first jurisdiction, a first plurality of product identifications, each product identification in the first plurality of product identifications corresponding to a unit of a first manufactured product in a plurality of units of the first manufactured product:
assign a plurality of product verification entries, each product verification entry in the plurality of product verification entries associated with a respective product identification in the first plurality of product identifications and an identity of the manufacture;
responsive to receiving, from a third electronic device associated with a first merchant, a first sub-plurality of product identifications in the first plurality of product identifications corresponding to a first sub-plurality of units in the first plurality of units of the first manufactured product received by the first merchant:
update product verification entries in the plurality of product verification entries corresponding to each of the first sub-plurality of product identifications in the first plurality of product identifications to include an identity of the first merchant, and
optionally, transmit, to the third electronic device associated with the first merchant, a chain of custody including at least confirmation that the first sub-plurality of units in the plurality of units of the first manufactured product received by the first merchant were manufactured by the first manufacturer;
responsive to receiving, from a fourth electronic device associated with a first customs agency of the first jurisdiction, a second sub-plurality of product identifications in the first plurality of product identifications corresponding to a second sub-plurality of units in the first plurality of units of the first manufactured product to be exported from the first jurisdiction, wherein the second sub-plurality of units is also a sub-plurality of the first sub-plurality of units:
update product verification entries in the plurality of product verification entries corresponding to each of the second sub-plurality of product identities in the first plurality of product identifications to include an identity of the first customs agency of the first jurisdiction, and
optionally, transmit, to the fourth electronic device associated with the first customs agency of the first jurisdiction, a chain of custody including at least confirmation that the second sub-plurality of units in the plurality of units of the first manufactured product to be exported from the first jurisdiction were manufactured by the first manufacturer;
responsive to receiving, from a fifth electronic device associated with a second customs agency of a second jurisdiction that is different from the first jurisdiction, the second sub-plurality of product identifications in the first plurality of product identifications corresponding to the second sub-plurality of units in the first plurality of units of the first manufactured product to be exported into the second jurisdiction:
update product verification entries in the plurality of product verification entries corresponding to each of the second sub-plurality of product identifications in the first plurality of product identifications to include an identity of the second customs agency of the second jurisdiction, and
optionally, transmit, to the fifth electronic device associated with the second customs agency of the second jurisdiction, a chain of custody including at least confirmation that the second sub-plurality of units in the plurality of units of the first manufactured product to be exported into the second jurisdiction were manufactured by the first manufacturer;
responsive to receiving, from a sixth electronic device associated with a second merchant, a third sub-plurality of product identifications in the first plurality of product identifications corresponding to a third sub-plurality of units in the first plurality of units of the first manufactured product to be sold direct to consumers, wherein the third sub-plurality of units is also a sub-plurality of the second sub-plurality of units:
update product verification entries in the plurality of product verification entries corresponding to each of the third sub-plurality of product identifications in the first plurality of product identifications to include an identity of the second merchant, and
optionally, transmit, to the sixth electronic device associated with the second merchant, a chain of custody including at least confirmation that the third sub-plurality of units in the first plurality of units of the first manufactured product to be sold direct to consumers were manufactured by the first manufacturer;
responsive to receiving, from a seventh electronic device associated with a consumer, a respective product identification in the third sub-plurality of product identifications corresponding to a respective unit in third sub-plurality of units in the first plurality of units of the first manufactured product prior to, while, of or after purchasing the product:
transmit, to the seventh electronic device associated with the consumer, a chain of custody including at least confirmation that the respective unit in the third sub-plurality of units in the first plurality of units of the first manufactured product was manufactured by the first manufacture; and
responsive to receiving, from an eighth electronic device associated with a final merchant, the respective product identification in the third sub-plurality of product identifications in the first plurality of product identifications corresponding to the respective unit in the third sub-plurality of units in the first plurality of units of the first manufactured product sold to a consumer by the final merchant:
update the product verification entry in the plurality of product verification entries corresponding to the respective unit in the third sub-plurality of units in the first plurality of units of the first manufactured product sold to the consumer to indicate that the unit was sold to a consumer.

2. The method of claim 1, wherein the non-transitory instructions, when executed by the one or more processors, further cause the electronic device to:
responsive to receiving, from one of the manufacture, the first merchant, or the second merchant, an identity of a final merchant authorized to sell the third sub-plurality of units in the first plurality of units of the first manufactured product:
update product verification entries in the plurality of product verification entries corresponding to each of the third sub-plurality of product identifications in the first plurality of product identifications to include an identity of the authorized final merchant; and
responsive to receiving, from the seventh electronic device associated with the consumer:
the respective product identification in the third sub-plurality of product identifications corresponding to the respective unit in third sub-plurality of units of the first manufactured product, and
an identity of a final merchant:
determine whether the identity of the final merchant received from the seventh electronic device associated with the consumer matches the identity of the authorized final merchant stored in the product verification entry corresponding to the respective product identification in the sub-plurality of product identifications received from the seventh electronic device associated with the consumer; and
transmit, to the seventh electronic device associated with the consumer, an indication whether the final merchant identified by the consumer is authorized to sell the respective unit in the third sub-plurality of units of the first manufactured product.

3. The method of claim 1, wherein tracking of the plurality of units of the first manufactured product is carried out in accordance with:
a first principle wherein tracking of product identifications in the first plurality of product identifications is carried out by recording the owners of certain units of the first manufactured product in the chain of custody from the manufacturer to a final consumer or
a second principle wherein tracking of product identifications in the first plurality of product identifications is carried out by recording the owners of certain units of the first manufactured product in the chain of custody from the manufacturer to the final consumer taking into account the time/period(s) of ownerships and location(s) of the units of the first manufactured product or,
a third principle wherein tracking of product identifications in the first plurality of product identifications is carried out by recording the owners of certain units of the first manufactured product in the chain of custody from the manufacturer to the final consumer taking into account the time/period(s) of ownerships for the units of the first manufactured product or
a fourth principle wherein tracking of product identifications in the first plurality of product identifications is carried out by recording the owners of certain units of the first manufactured product in the chain of custody from the manufacturer to the final consumer taking into account the location(s) of the unit(s) of the first manufactured product.

4. The method of claim 1, wherein the chain of custody between the manufacturer and the final consumer for a unit of the first manufactured product is direct or includes one or more wholesalers/merchants/customs.

5. The method of claim 4, wherein certain points of tracking are skipped, substituted and/or added in the chain of custody.

6. A computer-implemented method for confirming authenticity of a first document or file, performed on a server having at least one processor and memory storing at least one program for execution by the at least one processor to perform the method, the method comprising:
responsive to receiving from a first remote source (i) first biographical data for the first document or file, (ii) optionally a first security indicator for the document or file that comprises a checksum of the document or file and (iii) optionally a second security indicator for the document or file that comprises or is derived from one or more parameters of the document or file, performing an onboarding procedure that comprises:
assigning a first document validation identity to the first document or file,
optionally, concatenating a first salt to the first checksum,
applying a first cryptographic one-way function to the first checksum and, optionally, concatenated first salt to generate a first hashed checksum,
generating a first document validation entry for the first document or file, the first document validation entry comprising the first validation identity, the first biographical data, the first hashed checksum and, optionally, the first salt and, optionally, an identity of the first cryptographic hash function,
transmitting the first document or file validation identity back to the first remote source, and
storing the first document or file validation identity without storing the first document or file.

7. The computer-implemented method of claim 6, the method further comprising:
conditionally confirming authenticity of the first document or file responsive to receiving, from a second remote source a request that comprises the first document validation identity and a second checksum by a verification procedure that comprises:
identifying the first document validation entry based on the first document validation identity received from the second remote source,
optionally, retrieving the first salt from the identified first document validation entry,
optionally, concatenating the first salt to the second checksum,
applying the first cryptographic one-way function to the concatenated second checksum and first salt to generate a second hashed checksum, and
transmitting, to the second remote source:
in accordance with a determination that the second hashed checksum is identical to the first hashed checksum, an indication that the first document or file is authentic, and
in accordance with a determination that the second hashed checksum is not identical to the first hashed checksum, an indication that the authenticity of the first document or file cannot be confirmed.

8. The computer-implemented method of claim 6, wherein the first checksum is calculated according to a one or more checksum algorithms using at least a first subset of data from the document or file.

9. The computer-implemented method of claim 6, wherein the second security indicator is a checksum of the one or more parameters of the document or file.

10. The computer-implemented method of claim 9, wherein the one or more parameters comprises a number or spatial location of words in the document or file, a number or spatial location of letters or symbols in the document or file, a number or spatial location of digits in the document or file, a presence or spatial location of an object in a predetermined portion of the document or file.

11. The computer-implemented method of claim 6, wherein the one or more parameters comprises a number or spatial location of words in the document or file, a number or spatial location of letters or symbols in the document or file, a number or spatial location of digits in the document or file, a presence or spatial location of an object in a predetermined portion of the document or file.

12. A method, embodied as an electronic device associated with an auditing server, the first electronic device having one or more processors and a memory, wherein the memory stores:
a medical auditing database comprising a plurality of medical professional records, each medical professional record in the plurality of medical professional records corresponding to a respective medical professional in a plurality medical professionals and including:
an identity of the corresponding medical professional,
a medical service classification of the corresponding medical professional or job classification of the corresponding medical professional), and
a plurality of medical services records, each medical service record in the plurality of medical services records corresponding to a service event rendered by the corresponding medical professional and including a description of all medical charges arising out of, the service event; and
non-transitory instructions which, when executed by the one or more processors, cause the electronic device to:
generate a plurality of statistics for a first medical service classification, each statistic in the plurality of statistics for the first medical service corresponding to a measure of all medical charges associated with a first sub-plurality of medical services records corresponding to a medical professional associated with the first medical service classification,
rank each statistic in the plurality of statistics for the first medical service classification relative to each other statistic in the plurality of statistics for the first medical service; and
display the identity of any medical professionals associated with a respective statistic in the plurality of statistics that is an outlier from the majority of other statistics.
